(19) United States
(12) Patent Application Publication
(10) Pub. No.: US 2018/0337502 A1
(43) Pub. Date: Nov. 22, 2018

(54) Light Bulb Reflector 2

(71) Applicant: Maile Ledford Jones, Arvada, CO (US)

(72) Inventor: Maile Ledford Jones, Arvada, CO (US)

(21) Appl. No.: 15/598,267

(22) Filed: May 17, 2017

(51) Int. Cl. H01R 33/97; H01R 33/94; H01F 7/02; F21S 8/10

(52) U.S. Cl. CPC H01R 33/973; F21S 48/23; H01F 7/02; H01R 33/94

(57) ABSTRACT

Technical field: lighting. This object is an accessory. It is a reflector that can be installed into an existing luminaire assembly, typically ceiling lights or other metal light fixtures. This product creates more light. It is designed to sit above the light bulb. It is a reflector, is held up with a strong magnet that attaches to a metal light fixture. The claim: An accessory reflector designed to sit on the side of a light bulb (bulb series A, B, C, G, P, RP) in a luminaire assembly, sized accordingly to bulb series and bulb shapes; containing any percentage of reflecting ability, comprised of any composition of materials that are ideal and suitable; The reflector piece having a magnet that allows it to fasten to a light fixture.

### BACKGROUND OF THE INVENTION

This product was designed in pursuit to increase the amount of light that is emitted from a cfl or led light bulb through the use of reflection. The goal is to be able to eliminate the need for high watt bulbs. This product creates more light in ceiling luminaire assemblies without additional electricity, and reduces the need for high watt bulbs.

Most reflectors that are produced are for warehouse lights, grow lights, or other specialty where a lot of light is used. Some reflectors are built into lighting units and are part of the fixture casing.

Light Bulb Reflector 2 is an accessory that can be used with a variety of bulbs and lighting fixtures to make lighting more efficient and eliminate the need for high watt bulbs. Light Bulb Reflector 2 adds such an increase in total light that it can eliminate the need for dual bulbs as in a typical home ceiling lighting unit.

Light Bulb Reflector 2 is an accessory that can be used in various ceiling fixtures, refridgerators, or other various metal fixtures.

Most reflectors also have a significant amount of space between them and the bulb. Light Bulb Reflector 2 sits very close alongside the bulb and should not come contact with the bulb at center. The reflector becomes hot and should not be used in an enclosed lighting unit. Proper installation instructions and product safety instructions must accommodate Light Bulb Reflector for its proper use.

### BRIEF SUMMARY OF INVENTION

When Light Bulb Reflector is used in a lamp unit, additional light is created, which reduces the need for high watt bulbs. The effect of the use of this reflector in a lamp is an increase in total light.

### REFERENCE

a—Reflective Material
b—Magnet

### DESCRIPTION OF VIEWS IN DRAWINGS

FIG. 1) This is a view from the front. This is the front of the reflective material (a) which is designed to sit in a light fixture above the light bulb, typically in a ceiling light luminaire assembly.

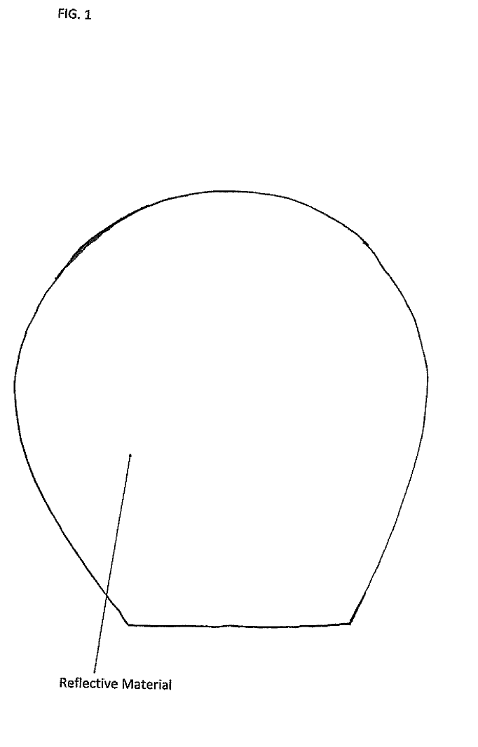

FIG. 2) This is a view from the back. This is the back of the reflective material (a) and the magnet that attached to it with jb weld which is made for high heat use(b).

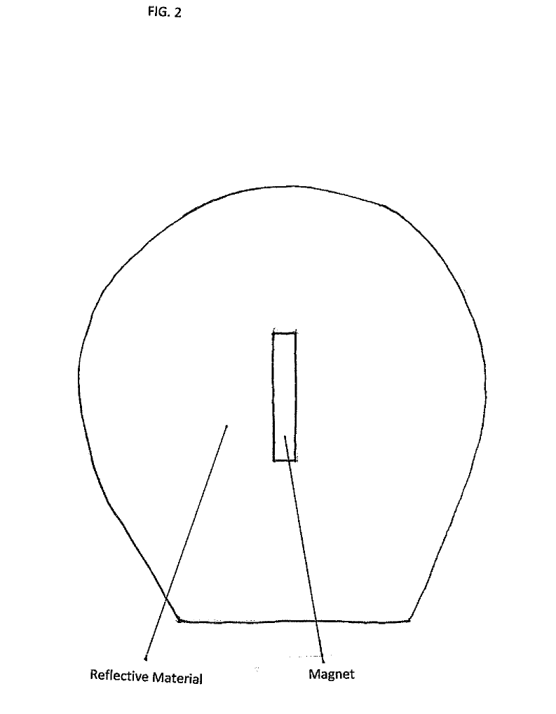

### DETAILED DESCRIPTION OF INVENTION

Light Bulb Reflector is made of a flat Coilzak sheet and a thin magnet. The Coilzak is cut into a rounded shape larger than the width and height of a standard led light bulb. Then a section is cut flat at the bottom so that it fits in a fixture with the light socket at the bottom. A thin magnet is glued onto the Coilzak with JB Weld glue. The reflector is designed to sit just above the light bulb creating more downward light.

In a typical ceiling light, the Light Bulb Reflector 2 and testing led light bulb has a reading with a lux light meter of 32% more light than with the led light bulb alone. Total light emitted by the lamp has been increased by up to 32%, which creates greater lighting efficiency.

### REQUEST NOT TO PUBLISH

Please do not publish my invention. I did find a way to select this as an option so I am including it here.

1. An accessory reflector piece designed to sit on the side of a light bulb. The reflector piece sized in a proportion larger than a standard led bulb. And sized proportionately as specified to each of the light bulb series sizes and bulb shapes: A, B, C, F, G, PS, RP, S, Compact Fluorescent Coils, Compact Fluorescent Plug In Lamps.
The reflector being flat or nearly flat or curved slightly toward the bulb so as to fit in a ceiling luminaire.
The reflector piece having any percentage of reflecting ability, comprised of any composition of materials that are ideal and suitable, including reflective lighting materials, mirrors, or mirror-like materials.
The reflector piece having a magnet to be attached to a light fixture.
The reflector piece being in proximity of nearly touching the bulb.

1. An accessory reflector piece having a magnet to be attached to a light fixture with [symbol]
